(19) United States
(12) Patent Application Publication
(10) Pub. No.: US 2024/0204553 A1
(43) Pub. Date: Jun. 20, 2024

(54) DUAL-BATTERY POWER MANAGEMENT SYSTEM AND METHOD CAPABLE OF AUTOMATICALLY DETERMINING BATTERY TYPE AND PERFORMING CHARGE-DISCHARGE PROTECTION

(71) Applicants: INVENTEC APPLIANCES (PUDONG) CORPORATION, SHANGHAI (CN); INVENTEC APPLIANCES CORPORATION, New Taipei City (TW); INVENTEC APPLIANCES (SHANGHAI) CO. LTD., SHANGHAI (CN)

(72) Inventors: SZU-CHENG WU, New Taipei City (TW); CHENG-HSIEN HSIAO, New Taipei City (TW)

(21) Appl. No.: 18/448,979

(22) Filed: Aug. 14, 2023

(30) Foreign Application Priority Data
Dec. 19, 2022 (TW) 111148649

(51) Int. Cl. H02J 7/00; H01M 10/42; H01M 10/44; H01M 10/48; H02J 7/34

(52) U.S. Cl. CPC H02J 7/007182; H01M 10/4221; H01M 10/425; H01M 10/441; H01M 10/482; H02J 7/0013; H02J 7/342; H01M 2220/20

(57) ABSTRACT

A dual-battery power management system and a method capable of automatically determining battery types and performing charging and discharging protection are provided. The system includes first and second battery modules, a bidirectional power converter, a voltage detection circuit and a processing circuit. The processing circuit is configured to: fully discharge the second battery module while charging the first battery module to obtain a battery capacity of the second battery module; using the first battery module to charge the second battery module according to a preset battery charging rate, and detect a voltage of the second battery module to obtain a first charging voltage change rate; determining a battery type of the second battery module according to a comparison table and the first charging voltage change rate; and controlling charging and discharging of the second battery module with a charging and discharging mechanism corresponding to the battery type.

### CROSS-REFERENCE TO RELATED PATENT APPLICATION

This application claims the benefit of priority to Taiwan Patent Application No. 111148649, filed on Dec. 19, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a power management system and method, and more particularly to a dual-battery power management system and method capable of automatically determining battery types and performing charging and discharging protection.

### BACKGROUND OF THE DISCLOSURE

In the existing electric motorcycles and scooters, a dual-battery system that can satisfy requirements in both the horsepower and endurance of the electric motorcycles and scooters is utilized. However, in the dual-battery system, although a connection configuration for the batteries can be switched to increase an output power of a motor, the battery type cannot be automatically determined for charging and discharging protection.

In addition, batteries are widely used in various equipment, including car starters, various portable equipment and tools, uninterruptible power supply systems, hybrid vehicles, and pure electric vehicles. When the storage battery is out of power, the batteries need to be replaced for vehicles adopting a battery swapping system, or need to be turned off and charged for vehicles adopting a stationary battery charging system.

In the existing power supply system using batteries, communication data required for parallel power supply, such as battery power, current, voltage, and the like, are not usually provided. To avoid long-term overcharging or over-discharging of the battery for the power supply system, it is necessary to perform self-testing to obtain battery information, thereby increasing the service life of the battery.

In detail, because different types of batteries have different physical characteristics, such as different voltage levels or current levels, caution should be exercised for controlling charging and discharging operations to avoid battery damage caused by overcharging or over discharging. Therefore, it is necessary to provide effective designs corresponding to charging methods for different types of batteries.

### SUMMARY OF THE DISCLOSURE

In response to the above-referenced technical inadequacies, the present disclosure provides a dual-battery power management system and method capable of automatically determining battery types and performing charging and discharging protection.

In one aspect, the present disclosure provides a dual-battery power management system capable of automatically determining battery types and performing charging and discharging protection, and the dual-battery power management system includes a first battery module, a second battery module, a bidirectional power converter, a voltage detection circuit and a processing circuit. The bidirectional power converter is electrically connected between the first battery module and the second battery module. The voltage detection circuit is configured to detect voltages of the first battery module and the second battery module. The processing circuit is electrically connected to the bidirectional power converter and the voltage detection circuit, and the processing circuit is configured to: fully discharge the second battery module while charging the first battery module, so as to obtain a battery capacity of the second battery module; control the bidirectional power converter to charge the second battery module with the first battery module according to a predetermined battery charging rate related to the battery capacity.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic block diagram of a dual-battery power management system according to one embodiment of the present disclosure;

FIG. 2A is a schematic circuit diagram of a bidirectional power converter, a voltage detection circuit and a processing circuit according to one embodiment of the present disclosure;

FIG. 2B is a timing diagram of signals under control of PWM charging and discharging in FIG. 2A;

FIG. 3 is a flowchart of a dual-battery power management method according to one embodiment of the present disclosure;

FIG. 4 is a detailed flowchart of steps S13 to S14 in FIG. 3;

FIG. 5 is a time sequence diagram of voltage changes in a driving situation of an electric vehicle in which the dual-battery power management method according to one embodiment of the present disclosure is applied; and

FIG. 6 is another flowchart of the dual-battery power management method according to one embodiment of the present disclosure.

### DETAILED DESCRIPTION OF THE EXEMPLARY EMBODIMENTS

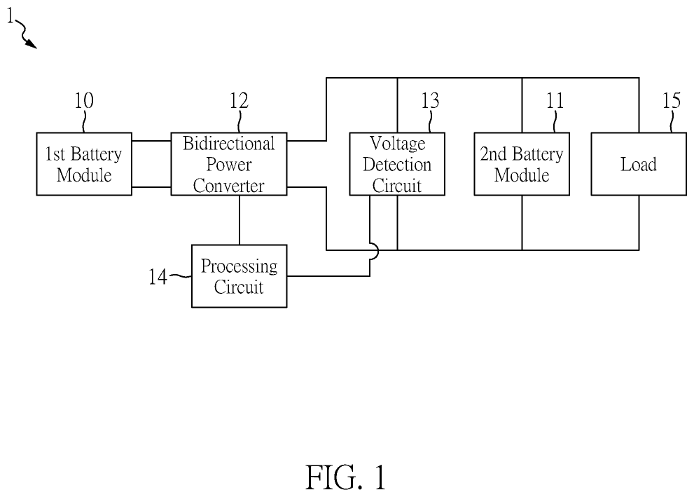

FIG. 1 is a schematic block diagram of a dual-battery power management system according to one embodiment of the present disclosure. Reference is made to FIG. 1, one embodiment of the present disclosure provides a dual-battery power management system 1 that can automatically determine a battery type and perform charge and discharge protection, and the dual-battery power management system 1 includes a first battery module 10, a second battery module 11, a bidirectional power converter 12, a voltage detection circuit 13, a processing circuit 14 and a load 15.

In the embodiment of the present disclosure, the dual-battery power management system 1 can be used as a part of a power management system of an electric vehicle, but the present disclosure is not limited thereto. In order to meet requirements for both horsepower and battery life of the electric vehicle, battery modules with different characteristics can be used, such as an endurance battery module and a power battery module. For example, compared with the endurance battery module, the power battery module can provide extra power required by the engine for acceleration and climbing, while the endurance battery module is used to provide a high-power capacity required for long-distance driving. In one embodiment of the present disclosure, the first battery module 10 can be the endurance battery module, and the second battery module 11 can be the power battery module, and in the dual-battery power management system 1, a connection configuration of the first battery module 10, the second battery module 11 and the load 15 can be switched according to different usage scenarios to meet the above requirements.

It should be noted that since different types of batteries have different physical characteristics, such as voltage or current, charge and discharge must be carefully controlled to avoid battery damage caused by overcharging or over discharging. The dual-battery power management system 1 provided by the embodiment of the present disclosure can detect different types of power batteries and provide corresponding charging and discharging mechanisms.

The bidirectional power converter 12 can be various types of bidirectional DC-DC power converters, such as boost, buck or buck-boost DC-DC power converters. In the embodiment of the present disclosure, the bidirectional power converter 12 is electrically connected between the first battery module 10 and the second battery module 11, and is configured to control the second battery module 11 (i.e., the power battery module) to discharge to the first battery module 10 (i.e., the endurance battery module), thereby detecting a battery capacity of the second battery module 11, and can also control the first battery module 10 to charge the second battery module 11. The voltage detection circuit 13 is used to detect voltages of the first battery module 10 and the second battery module 11, and to determine a battery type of the second battery module 11 by observing electrical changes during the charging process.

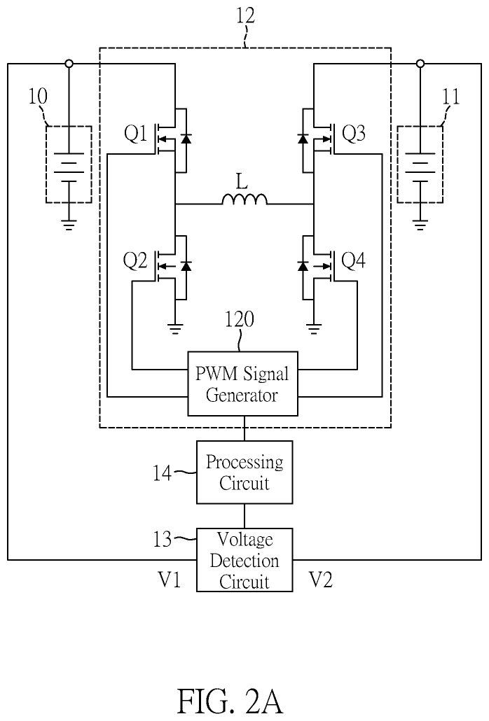

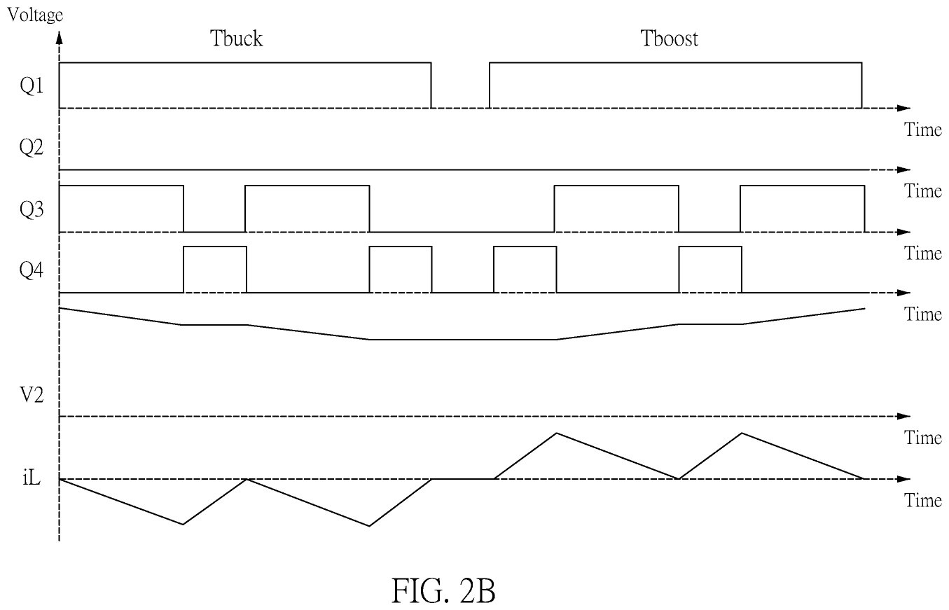

Further reference can be made to FIG. 2A and FIG. 2B. FIG. 2A is a schematic circuit diagram of a bidirectional power converter, a voltage detection circuit and a processing circuit according to one embodiment of the present disclosure, and FIG. 2B is a timing diagram of signals under control of PWM charging and discharging in FIG. 2A. As shown in FIG. 2A, the bidirectional power converter 12 having a buck-boost DC-DC power converter architecture is taken as an example, the bidirectional power converter 12 can include switches Q1, Q2, Q3 and Q4, inductor L and a pulse-width modulation (PWM) Signal Generator 120.

In this case, the switches Q1, Q2, Q3, and Q4 can be, for example, metal-oxide-semiconductor field-effect transistors (MOSFETs), and the voltage detection circuit 13 can detect a difference between an input voltage (for example, a voltage V1 of the first battery module 10) and the output voltage (for example, a voltage V2 of the second battery module 11) to automatically enter a buck stage Tbuck or a boost stage Tboost shown in FIG. 2B. Such a feature makes the buck-boost DC-DC power converter very suitable for battery-powered applications, and can provide a stable voltage from a high voltage state when the battery is fully charged to a low voltage state when the battery is completely discharged.

From signal levels of the switches Q1, Q2, Q3, and Q4 in FIG. 2B, the voltage V2, and an inductor current iL, it can be seen that in response to entering the buck stage Tbuck, the switch Q1 is turned on, the switch Q2 is turned off, and the switches Q3 and Q4 are turned on in turn. At this time, the first battery module 10 charges the second battery module 11. In response to entering the boost stage Tboost, the switch Q1 is turned on, the switch Q2 is turned off, the switches Q4 and Q3 are turned on in turn, and the second battery module 11 is discharged to the first battery module 10.

In this configuration, the voltage detection circuit 13 can, for example, include a voltage divider circuit or a comparator circuit, and the processing circuit 14 can be, for example, a (MPU) or a micro-Micro-Processor Unit controller unit including an analog-to-digital converter. The processing circuit 14 can convert an output signal of the voltage detection circuit 13 into a digital signal to obtain values of the voltages V1 and V2, and then control the PWM signal generator 120 to generate corresponding switch signals according to the values of the voltages V1 and V2, so as to control the first battery module 10 to charge the second battery module 11, or to control the second battery module 11 to discharge to the first battery module 10.

In addition, the processing circuit 14 can include a memory for storing program codes and data, and the program codes can be pre-designed to control the first battery module 10 to charge the second battery module 11 in a predetermined manner, or to control the second battery module 11 to discharge the first battery module 10, and to simultaneously record a charging voltage and a discharging voltage.

The load 15 is electrically connected to the bidirectional power converter 12 and the second battery module 11, and is connected in parallel with the second battery module 11 and the voltage detection circuit 13. In a case that the dual-battery power management system 1 is applied to an electric vehicle, the load 15 can be, for example, a power module including a motor controller and a motor. However, the above is merely an example, and the present disclosure is not limited thereto.

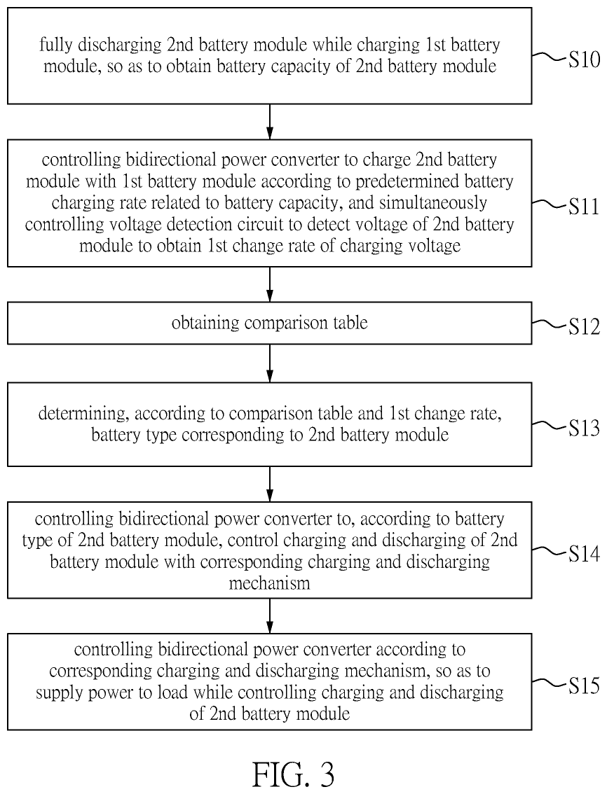

FIG. 3 is a flowchart of a dual-battery power management method according to one embodiment of the present disclosure. As shown in FIG. 3, one embodiment of the present disclosure provides a dual-battery power management method that can automatically determine the battery type and perform charge and discharge protection. The method is applicable to the aforementioned dual-battery power management system 1. The dual-battery power management method includes configuring the processing circuit 14 to perform the following steps:

Step S10: fully discharging the second battery module while charging the first battery module, so as to obtain a battery capacity of the second battery module. This step is to control the bidirectional power converter 12 to control the second battery module 11 (e.g., the power battery module) to be discharged to the first battery module 10 (e.g., the endurance battery module), thereby detecting the battery capacity of the second battery module 11, and to determine safe charging conditions used for charging the second battery module 11 in subsequent steps. It should be noted that in this step, the first battery module 10 is preset to be fully discharged and has a larger capacity than the second battery module 11, such that a condition in which the second battery module 11 is fully discharged can be met.

Step S11: controlling the bidirectional power converter to charge the second battery module with the first battery module according to a predetermined battery charging rate related to the battery capacity, and simultaneously controlling the voltage detection circuit to detect the voltage of the second battery module to obtain a first change rate of a charging voltage.

In detail, the battery capacity in steps S10 and S11 can be represented by a charge-discharge rate (C-rate). For example, if the battery capacity obtained in step S10 is set as 1C according to a current that can fully discharge the second battery module 11 in one hour, then a predetermined battery charging rate related to the battery capacity is then set to range from 0.2 C to 0.3 C. Preferably, the predetermined battery charging rate can be set to 0.25 C. Furthermore, in the process of charging the second battery module 11 at the above-mentioned predetermined battery charging rate, the voltage of the second battery module 11 is detected by the voltage detection circuit 13, and a variation of the voltage with time is recorded to obtain the first change rate of the charge voltage can be obtained. For another example, if the battery capacity is 1 Ah, then 0.25 C is equal to 0.25 A.

Step S12: obtaining a comparison table. In detail, the comparison table can be stored in the memory of the processing circuit 14 in a form of data, or can be stored in a register. The comparison table defines correspondences respectively between a plurality of change rate ranges of the charge voltage and a plurality of battery types. In general, with different types of batteries, there will be different charging curves, which include corresponding charging voltages and charging currents under different power levels.

For example, the battery types in the comparison table can include a lead-acid battery, a lithium-ion battery, and a lithium iron phosphate battery, which correspond to a first change rate range, a second change rate range, and a third change rate range of the charge voltage, respectively. In some embodiments, the first change rate range can, for example, range from 1.9×10⁻⁵ V/s to 3.5×10⁻⁵ V/s, and the second change rate range can, for example, range from 4.3×10⁻⁵ V/s to 8.1×10⁻⁵ V/s, and the third change rate range can, for example, range from 1.8×10⁻⁵ V/s to 1×10⁻⁵ V/s.

Step S13: determining, according to the comparison table and the first change rate, the battery type corresponding to the second battery module. In this step, the first change rate can be compared with the change rates in the comparison table, for example, by determining which of the above-mentioned first to third change rate ranges that the first change rate is in, to determine the corresponding battery type.

Step S14: controlling the bidirectional power converter to, according to the battery type of the second battery module, control charging and discharging of the second battery module with a corresponding charging and discharging mechanism.

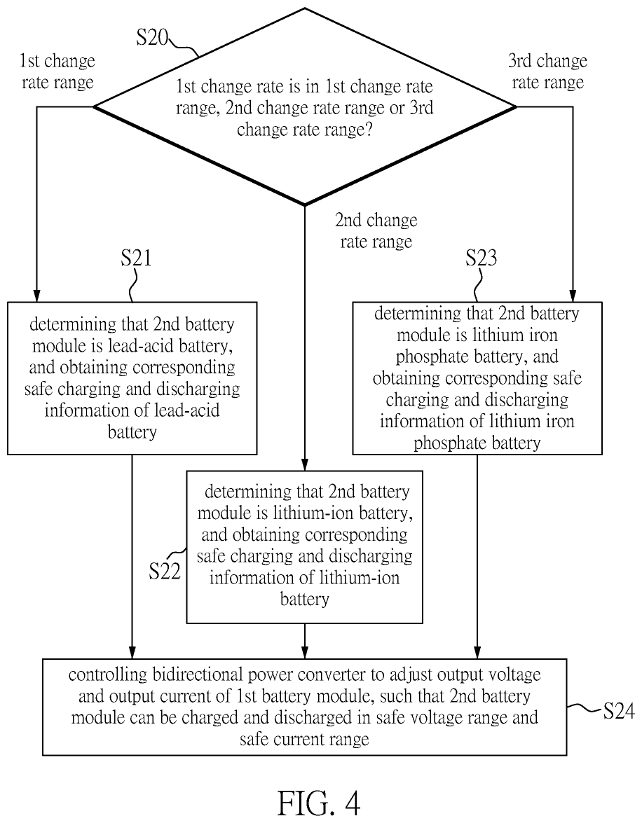

Reference is made to FIG. 4, which is a detailed flowchart of steps S13 to S14 in FIG. 3. As shown in FIG. 4, step S13 can further include step S20:

determining whether the first change rate is in the first change rate range, the second change rate range or the third change rate range.

In response to determining that the first change rate is within the first change rate range, the method proceeds to step S21: determining that the second battery module is a lead-acid battery, and obtaining the corresponding safe charging and discharging information of the lead-acid battery. The safe charging and discharging information includes a safe voltage range and a safe current range defined according to the charging and discharging curve of the lead-acid battery.

In response to determining that the first change rate is within the second change rate range, the method proceeds to step S22: determining that the second battery module is a lithium-ion battery, and obtaining the corresponding safe charging and discharging information of the lithium-ion battery. The safe charging and discharging information includes a safe voltage range and a safe current range defined according to the charging and discharging curve of the lithium-ion battery.

In response to determining that the first change rate is within the third change rate range, the method proceeds to step S23: determining that the second battery module is a lithium iron phosphate battery, and obtaining the corresponding safe charging and discharging information of the lithium iron phosphate battery. The safe charging and discharging information includes a safe voltage range and a safe current range defined according to the charging and discharging curve of the lithium iron phosphate battery.

Next, the method proceeds to step S24: controlling the bidirectional power converter to adjust an output voltage and an output current of the first battery module, such that the second battery module can be charged and discharged in the safe voltage range and the safe current range.

Therefore, the output voltage and the output current of the first battery module 10 (the endurance battery module) can be controlled through the bidirectional power converter 12 to protect the second battery module 11 (the power battery module). In addition, the above method provided by the present disclosure can provide appropriate voltages under different charging voltage specifications, and can also accurately control the charging voltage according to the condition of the battery.

In the step S20, in response to the first change rate being not within any of the first, second and third change rate ranges, one among the change rate ranges that is closest to the first change rate is obtained, and the battery type corresponding to the second battery module is determined according to the battery type having the one among the change rate ranges that is closest to the first change rate.

Reference is made to FIG. 3, the method proceeds to step S15: controlling the bidirectional power converter according to the corresponding charging and discharging mechanism, so as to supply power to the load while controlling the charging and discharging of the second battery module.

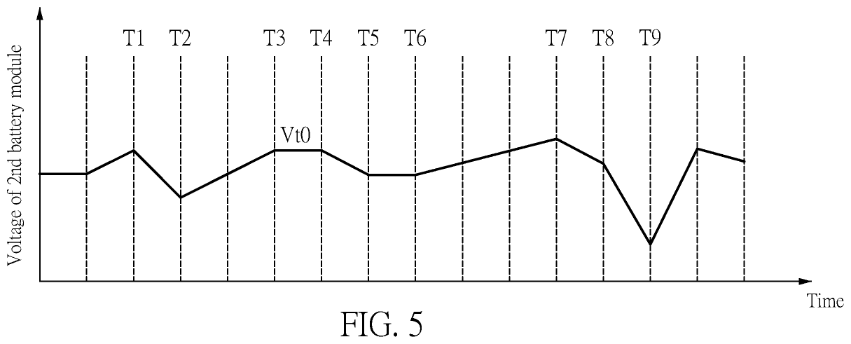

Reference is made to FIG. 5, which is a time sequence diagram of voltage changes in a driving situation of an electric vehicle in which the dual-battery power management method according to one embodiment of the present disclosure is applied. As shown in FIG. 5, an application scenario of the present embodiment takes a driving electric vehicle as an example. In order to avoid over discharge of the second battery module 11 (power battery module), the first battery module 10 (endurance battery module) is required to assist in supplying power, and the processing circuit 14 can control the output current of the first battery module 10 (endurance battery module) according to the flow mentioned above.

Between time T1 and T2, the electric vehicle is exemplified to be accelerating on a roadway. At this time, the second battery module 11 (power battery module) continues to be discharged, and the processing circuit 14 cooperates with the voltage detection circuit 13 to continuously monitor the voltage of the second battery module 11. At time T2, the processing circuit 14 determines that the second battery module 11 is about to exceed a safe discharge voltage range, and then controls the bidirectional power converter 12 to control the first battery module 10 (endurance battery module) to be discharged, so as to increase the output current to maintain the discharge voltage of the second battery module 11 (power battery module) at a voltage Vt0 (as shown between time T3 and T4).

Between time T5 and T6, the electric vehicle is exemplified to slide on the roadway and stop traveling. At this time, power required by the load 15 (motor module) decreases, and the processing circuit 14 controls the bidirectional power converter 12 to control the first battery module 10 (endurance battery module) to charge the second battery module 11 (power battery module), and the voltage of the second battery module 11 starts to rise. During a charging process (time T6 to T7), the processing circuit 14 controls the bidirectional power converter 12 to charge the second battery module 11 in the safe voltage range and the safe current range corresponding to the second battery module 11.

Between time T8 and T9, when the electric vehicle is exemplified to start accelerating on the roadway or start climbing a hill, the second battery module 11 (power battery module) continues to be discharged, and the processing circuit 14 cooperates with the voltage detection circuit 13 to continue monitoring the voltage of the second battery module 11. At time T9, the processing circuit 14 determines that the second battery module 11 is about to exceed the safe discharge voltage range, then controls the bidirectional power converter 12 to control the first battery module 10 (endurance battery module) to be discharged, so as to increase the output current to share the current supplied to the load 15.

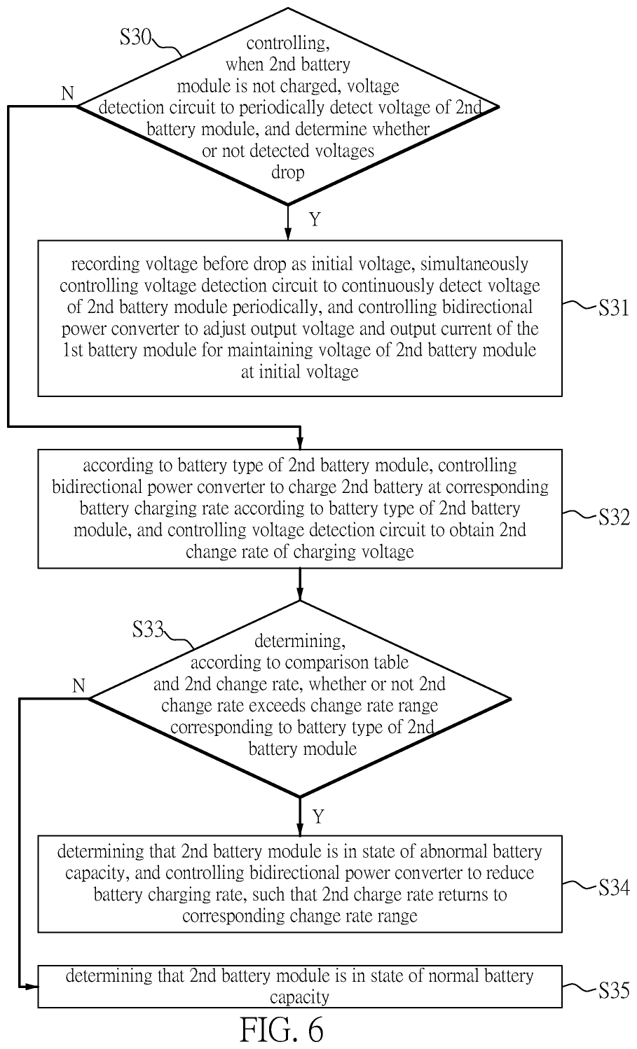

FIG. 6 is another flowchart of the dual-battery power management method according to one embodiment of the present disclosure. Reference is made to FIG. 6, the dual-battery power management method in the present embodiment of the present disclosure also includes performing the following steps:

Step S30: controlling, when the second battery module is not charged, the voltage detection circuit to periodically detect the voltage of the second battery module, and determine whether or not the detected voltages drop.

In response to determining that the detected voltages drop, the method proceeds to step S31: recording the voltage before a drop as an initial voltage, simultaneously controlling the voltage detection circuit to continuously detect the voltage of the second battery module periodically, and controlling the bidirectional power converter to adjust an output voltage and an output current of the first battery module for maintaining the voltage of the second battery module at the initial voltage.

If it is determined in step S30 that the detected voltages do not drop, the method proceeds to step S32: according to the battery type of the second battery module, controlling the bidirectional power converter to charge the second battery at the corresponding battery charging rate according to the battery type of the second battery module, and controlling the voltage detection circuit to obtain a second change rate of the charging voltage. For example, the lead-acid battery can be charged at 0.25 C, the lithium-ion battery can be charged at 0.5 C, or the lithium iron phosphate battery can be charged at 1 C.

Step S33: determining, according to the comparison table and the second change rate, whether or not the second change rate exceeds the change rate range corresponding to the battery type of the second battery module. More precisely, it is determined whether or not the second charging voltage change rate exceeds the change rate range corresponding to the battery type of the second battery module multiplied by a predetermined ratio. In specific embodiments, the predetermined ratio can be, for example, 1.3. Therefore, for the lead-acid battery, it is determined whether or not the second change rate is greater than 2.72×10⁻⁵×1.3 V/s; for the lithium-ion battery, it is determined whether or not the second change rate is greater than 6.25×10⁻⁵×1.3 V/s; for the lithium iron phosphate battery, it is determined whether the second change rate is greater than 1.41×10⁻⁵×1.3 V/s.

If yes, the method proceeds to step S34: determining that the second battery module is in a state of abnormal battery capacity, and controlling the bidirectional power converter to reduce the battery charging rate, such that the second charge rate returns to the corresponding change rate range. For example, for the lead storage battery, the second charging voltage is maintained at 2.72×10⁻⁵ V/s; for the lithium-ion battery, the second charging voltage is maintained at 6.25×10⁻⁵ V/s; for the lithium iron phosphate battery, the second charging voltage is maintained at 1.41×10⁻⁵ V/s. If not, the method proceeds to step S35: determining that the second battery module is in a state of normal battery capacity.

Therefore, by monitoring a voltage state of the second battery module 11 and performing charging and discharging control for different types of the second battery module 11, a service life of the second battery module 11 can be increased.

In conclusion, in the dual-battery power management system and method capable of automatically determining battery types and performing charging and discharging protection provided by the present disclosure, the battery type can be automatically determined through charging and discharging operations. Therefore, appropriate voltage can be provided under any conditions, and corresponding charging and discharging control mechanisms are executed for different types of batteries, thereby increasing the service life of the battery.

In addition, there is a lower cost involved by employing the voltage detection method, as compared to the cost for using a current detection method. Moreover, by determining a working state of the battery, a safe current can be used for charging, and a large current can also be provided by a device for discharging to reduce a discharging burden of the battery and prolong battery life.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

What is claimed is:

1. A dual-battery power management system capable of automatically determining battery types and performing charging and discharging protection, the dual-battery power management system comprising:
a first battery module;
a second battery module;
a bidirectional power converter electrically connected between the first battery module and the second battery module;
a voltage detection circuit configured to detect voltages of the first battery module and the second battery module; and
a processing circuit electrically connected to the bidirectional power converter and the voltage detection circuit, wherein the processing circuit is configured to:
fully discharge the second battery module while charging the first battery module, so as to obtain a battery capacity of the second battery module;
control the bidirectional power converter to charge the second battery module with the first battery module according to a predetermined battery charging rate related to the battery capacity, and simultaneously control the voltage detection circuit to detect the voltage of the second battery module to obtain a first change rate of a charging voltage;
obtain a comparison table, which defines corresponding relationships respectively between a plurality of change rate ranges of the charging voltage and a plurality of battery types;
determine, according to the comparison table and the first change rate, the battery type corresponding to the second battery module; and
control the bidirectional power converter to, according to the battery type of the second battery module, control charging and discharging of the second battery module with a corresponding charging and discharging mechanism.

2. The dual-battery power management system according to claim 1, wherein the step of controlling the charging and discharging of the second battery module with the corresponding charging and discharging mechanism includes:
obtaining safe charging and discharging information corresponding to the battery type of the second battery module, wherein the safe charging and discharging information defines a safe voltage range and a safe current range; and
controlling the bidirectional power converter to adjust an output voltage and an output current of the first battery module, such that the second battery module can be charged and discharged in the safe voltage range and the safe current range.

3. The dual-battery power management system according to claim 1, wherein the predetermined battery charging rate related to the battery capacity ranges from 0.2 C to 0.3 C.

4. The dual-battery power management system according to claim 1, wherein the battery types include a lead-acid battery, a lithium-ion battery and a lithium iron phosphate battery, which correspond to a first change rate range, a second change rate range and a third change rate range of the charging voltage, respectively.

5. The dual-battery power management system according to claim 4, wherein the first change rate range ranges from 1.9×10⁻⁵ V/s to 3.5×10⁻⁵ V/s, and the second change rate range ranges from 4.3×10⁻⁵ V/s 5 V/s to 8.1×10⁻⁵ V/s, and the third change rate range ranges from 1.8×10⁻⁵ V/s to 1×10⁻⁵ V/s.

6. The dual-battery power management system according to claim 1, wherein, in the step of determining the battery type corresponding to the second battery module according to the comparison table and the first change rate, in response to the first change rate being not within any of the change rate ranges, determining the battery type corresponding to the second battery module to be the battery type having one among the change rate ranges that is closest to the first change rate.

7. The dual-battery power management system according to claim 1, wherein the processing circuit is further configured to:
control, when the second battery module is not charged, the voltage detection circuit to periodically detect the voltage of the second battery module, and determine whether or not the detected voltages drop;
in response to determining that the detected voltages drop, record the voltage before a drop as an initial voltage, simultaneously control the voltage detection circuit to continuously detect the voltage of the second battery module periodically, and control the bidirectional power converter to adjust an output voltage and an output current of the first battery module for maintaining the voltage of the second battery module at the initial voltage.

8. The dual-battery power management system according to claim 7, wherein the comparison table further defines correspondences respectively between the battery types and a plurality of battery charging rates, and the processing circuit is further configured to, in response to determining that the detected voltages do not drop:
control the bidirectional power converter to charge the second battery at the corresponding battery charging rate according to the battery type of the second battery module; control the voltage detection circuit to obtain a second change rate of the charging voltage;
determine, according to the comparison table and the second change rate, whether or not the second change rate exceeds the change rate range corresponding to the battery type of the second battery module, if yes, determine that the second battery module is in a state of abnormal battery capacity and control the bidirectional power converter to reduce the battery charging rate, such that the second charge rate returns to the corresponding change rate range, and if not, determine that the second battery module is in a state of normal battery capacity.

9. A dual-battery power management system capable of automatically determining battery types and performing charging and discharging protection, suitable for a dual-battery power management system including a first battery module, a second battery module, a bidirectional power converter electrically connected between the first battery module and the second battery module, a voltage detection circuit and a processing circuit, and the dual-battery power management method comprising: configuring the processing circuit to:
fully discharge the second battery module while charging the first battery module, so as to obtain a battery capacity of the second battery module;
control the bidirectional power converter to charge the second battery module with the first battery module according to a predetermined battery charging rate related to the battery capacity, and simultaneously control the voltage detection circuit to detect the voltage of the second battery module to obtain a first change rate of a charging voltage;
obtain a comparison table, which defines corresponding relationships respectively between a plurality of change rate ranges of the charging voltage and a plurality of battery types;
determine, according to the comparison table and the first change rate, the battery type corresponding to the second battery module; and
control the bidirectional power converter to, according to the battery type of the second battery module, control charging and discharging of the second battery module with a corresponding charging and discharging mechanism.

10. The dual-battery power management method according to claim 9, wherein the step of controlling the charging and discharging of the second battery module with the corresponding charging and discharging mechanism includes:
obtaining safe charging and discharging information corresponding to the battery type of the second battery module, wherein the safe charging and discharging information defines a safe voltage range and a safe current range;
controlling the bidirectional power converter to adjust an output voltage and an output current of the first battery module, such that the second battery module can be charged and discharged in the safe voltage range and the safe current range.

11. The dual-battery power management method according to claim 9, wherein the predetermined battery charging rate related to the battery capacity ranges from 0.2 C to 0.3 C.
